(19) United States
(12) Patent Application Publication
(10) Pub. No.: US 2005/0255759 A1
(43) Pub. Date: Nov. 17, 2005

(54) Electrical connector terminal

(76) Inventors: Ming Chun Lai, Tucheng City (TW); Jizu Luo, Dong-Guan City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 10/846,604

(22) Filed: May 17, 2004

(51) Int. Cl. H01R 13/40

(52) U.S. Cl. 439/874

(57) ABSTRACT

An electrical connector terminal of the present invention is disclosed. The electrical connector terminal has a contact portion for electrically contacting with a mating connector terminal, and a welding portion extending from the contact portion. The welding portion is centerwardly warped at opposite sides thereof with a shape adapting to be welded to a cable. A guiding portion is formed by tapering a free end of the welding portion, namely the width of the guiding portion becomes narrow gradually for guiding the welding portion inserting through a through-hole of a PCB. Therefore, the electrical connector terminal can also be applied to be soldered on the PCB by through-hole soldering.

### FIELD OF THE INVENTION

The invention relates to an electrical connector terminal. More particularly, the invention relates to an electrical connector terminal adapted to be selectively welded to a cable or soldered on a PCB (Printed Circuit Board) by through-hole soldering.

### THE RELATED ART

With reference to FIG. 10, an electrical connector terminal 210 is shown according to a prior art. The electrical connector terminal 210 has a contact portion 211 for electrically contacting with a mating connector terminal. One end of the terminal 210 has a welding portion 212, or called solder cup, which is centerwardly warped at opposite sides with a shape adapted to hold wires of a cable and solder for soldering the cable to the terminal 210. The other end of the terminal 210 has a limit portion 214 which extends into a horizontal plane. After the terminal 210 is fit into a connector housing, the limit portion 214 limits the contact portion 211 projecting to a certain height, thereby makes the contact portion 211 produce a beforehand resilience.

Because the welding portion 212 has a substantially equal width along its extending direction, it is inconvenient to insert the terminal 210 into a through-hole of a PCB. Furthermore, a bottom of the welding portion 212 is uneven. Therefore, the electrical connector terminal 210 cannot be applied to directly connect a PCB by either through-hole soldering or SMT (Surface Mount Technology) soldering. The terminal 210 can only be applied to be soldered to a cable. Therefore, there is a need for an electrical connector terminal that can overcome the above shortcoming.

### SUMMARY OF THE INVENTION

An objective of the present invention is to provide an electrical connector terminal which is adapted to be selectively welded to a cable or soldered on a PCB by through-hole soldering.

To achieve the above objective, the present invention provides an electrical connector terminal. The terminal has a contact portion for electrically contacting with a mating connector terminal, and a welding portion extending from the contact portion. The welding portion is centerwardly warped at opposite sides thereof with a shape adapted to hold wires of a cable and solder for soldering the cable to the terminal. A guiding portion is formed by tapering a free end of the welding portion, that is to say, the width of the guiding portion becomes narrow gradually, and therefore the welding portion can be readily inserted into a through-hole of a PCB guided by the guiding portion.

In order to make the electrical connector terminal insert into a through-hole easily, the guiding portion may be shaped into a trapezium, a triangle or an arc.

Therefore, the electrical connector terminal can be used either to be welded to a cable or to be soldered on a PCB by through-hole soldering.

### BRIEF DESCRIPTION OF THE DRAWINGS

The present invention will be apparent to those skilled in the art by reading the following description of embodiments thereof, with reference to the attached drawings, in which:

FIG. 1 is a perspective view of the first embodiment of the electrical connector terminal according to the present invention;

FIG. 2 is a perspective view of an electrical connector assembled with the electrical connector terminal shown in FIG. 1;

FIG. 3 is a perspective view of the assembly of the electrical connector terminal and the insulating body of the electrical connector.

FIG. 4 is a perspective view of a cable welded to the electrical connector;

FIG. 5 is an enlarged view of the portion V of FIG. 4;

FIG. 6 is a schematic view of the electrical connector mounted on a PCB;

FIG. 7 is an enlarged view of the portion VII of FIG. 6;

FIG. 8 is a perspective view of the second embodiment of the electrical connector terminal according to the present invention;

FIG. 9 is a perspective view of the third embodiment of the electrical connector terminal according to the present invention; and

FIG. 10 is a perspective view of an electrical connector terminal according to a prior art.

### DETAILED DESCRIPTION OF THE PREFERRED EMBODIMENT

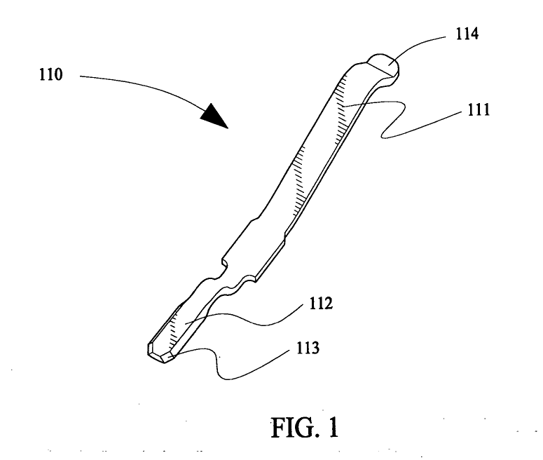

With reference to FIG. 1, a first embodiment of a electrical connector terminal according to the present invention is shown. The electrical connector terminal 110 has a contact portion 111 for electrically contacting with a mating connector terminal. One end of the terminal 110 has a welding portion 112 which is centerwardly warped at opposite sides thereof and shaped into a portion of a cup substantially, so the welding portion 112 is also called solder cup. A guiding portion 113 is formed by tapering a free end of the welding portion 112, that is to say, the width of the guiding portion 113 becomes narrow gradually. In the first embodiment, the guiding portion 113 is shaped into a trapezium. The other end of the terminal 110 has a limit portion 114 which extends into a horizontal plane.

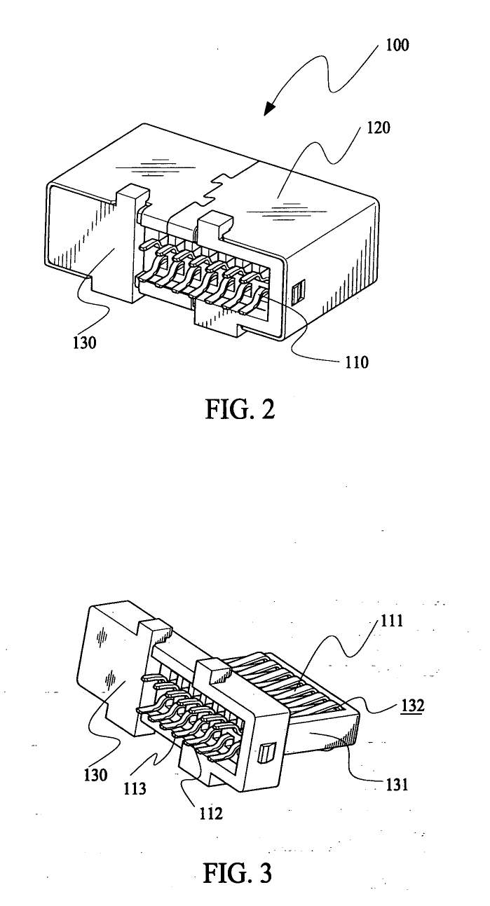

With reference to FIG. 2, FIG. 2 shows an electrical connector 100 assembled with a plurality of the electrical connector terminals 110 shown in FIG. 1. The electrical connector 100 further includes a housing 120 and an insulating body 130 which is held in the housing 120.

With reference to FIG. 3, a platform 131 reaches out from a front face of the insulating body 130. A plurality of holding slots 132 used to hold the contact portion 111 of the electrical connector terminal 110 are formed in the platform 131. According to each holding slot 132, a limit slot (that is not shown) is provided for stopping the limit portion 114 therein. The limit portion 114 limits the contact portion 111 projecting to a certain height, thereby makes the contact portion 111 produce a beforehand resilience. The welding portion 112 and the guiding portion 113 reach out from a back face of the insulating body 130.

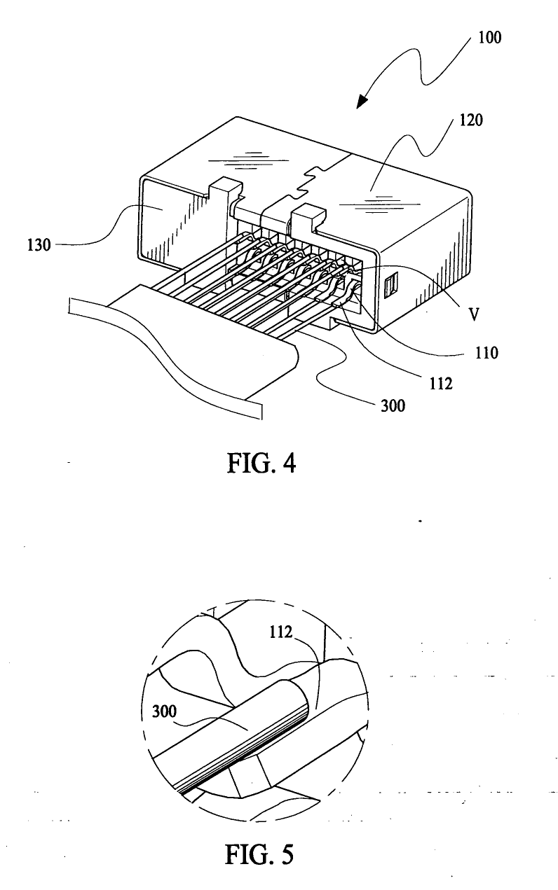

With reference to FIG. 4 and FIG. 5, it is shown that wires of a cable 300 is welded in the welding portion 112 of the electrical connector terminal 110. Because the welding portion 112 is shaped into a portion of a cup substantially, the welding portion 112 conveniently holds wires of a cable 300 and solder as soldering the cable to the terminal 110.

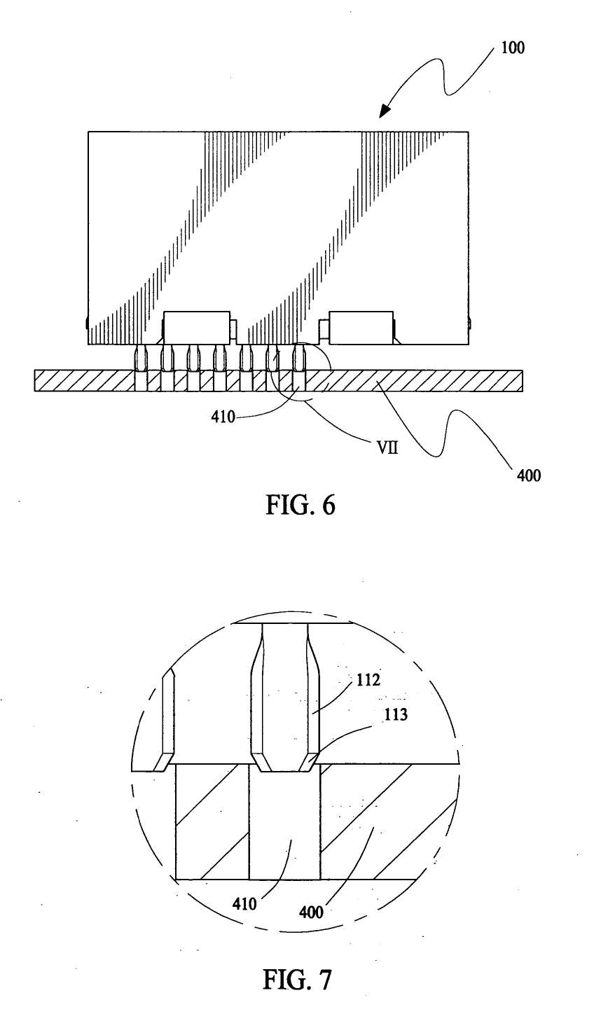

With reference to FIG. 6 and FIG. 7, it is shown that the electrical connector 100 is welded on a PCB 400. Because the width of the guiding portion 113 becomes narrow gradually, the guiding portion 113 facilitates the welding portion 112 inserting into a through-hole 410 of the PCB 400. Then the electrical connector terminal 110 is mounted on the PCB 400 by through-hole soldering.

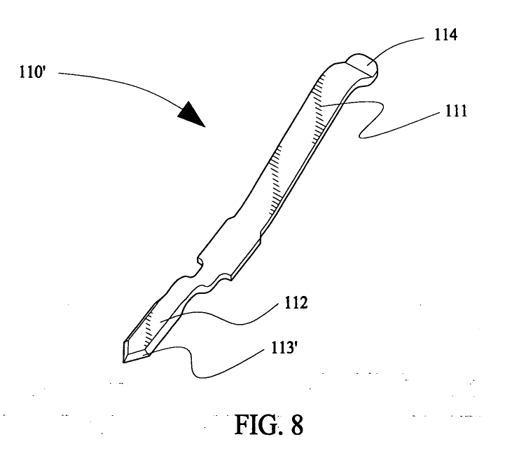

With reference to FIG. 8, FIG. 8 shows the second embodiment of the electrical connector terminal. The electrical connector terminal 110′ shown in FIG. 8 is similar with the electrical connector terminal 110 shown in FIG. 1, and the difference is that the guiding portion 113′ of the electrical connector terminal 110′ is shaped into a triangle.

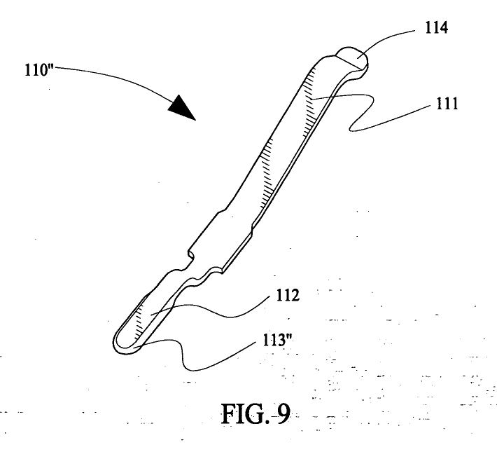

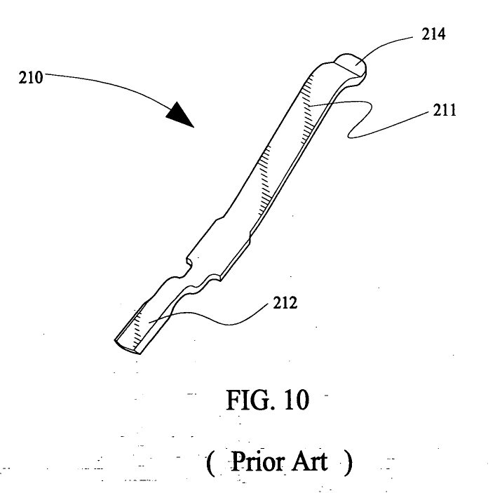

With reference to FIG. 9, FIG. 9 shows the third embodiment of the electrical connector terminal. The electrical connector terminal 110″ shown in FIG. 9 is similar with the electrical connector terminal 110 shown in FIG. 1 except that the guiding portion 113″ of the electrical connector terminal 110″ is shaped into an arc.

1-4. (canceled)

5. An electrical connector assembly comprising:
a housing and an insulating body disposed therein, said insulating body including a platform defining a plurality of holding slots; and,
a plurality of terminals coupled to said platform, each said terminal including a contact portion extending longitudinally from a welding portion;
said contact portion being retained in resiliently biased manner by one of said holding slots of said platform;
said welding portion extending from said holding slot to define a roundedly cupped inner region longitudinally terminated by a bilaterally tapering guiding portion.

6. The electrical connector assembly as recited in claim 5, wherein said guiding portion defines a trapezium contour.

7. The electrical connector assembly as recited in claim 5, wherein said guiding portion defines a triangular contour.

8. The electrical connector assembly as recited in claim 5, wherein said guiding portion defines an arced contour.
